(19) United States
(12) Patent Application Publication
(10) Pub. No.: US 2023/0263209 A1
(43) Pub. Date: Aug. 24, 2023

(54) AN APPARATUS AND METHOD FOR MANUFACTURING A CONSUMABLE FOR AN AEROSOL PROVISION SYSTEM

(71) Applicant: Nicoventures Trading Limited, LONDON (GB)

(72) Inventor: Josef DRIVER, London (GB)

(21) Appl. No.: 18/043,614

(22) PCT Filed: Sep. 1, 2021
(86) PCT No.: PCT/GB2021/052260

§ 371 Date: Mar. 1, 2023

(30) Foreign Application Priority Data
Sep. 1, 2020 (GB) 2013714.7

(51) Int. Cl. A24C 5/34; A24C 5/01; A24C 5/18; A24C 5/345; G01N 21/892; G01N 21/89

(52) U.S. Cl. CPC A24C 5/3412; A24C 5/01; A24C 5/1828; A24C 5/345; G01N 21/892; G01N 21/8914; G01N 21/8901

(57) ABSTRACT

An apparatus for manufacturing a consumable for an aerosol provision system. The apparatus includes a feeding apparatus for receiving and supplying a sheet of aerosol-generating material along a conveyance path, and a sensor configured to detect information indicative of defects in the sheet as the sheet passes along the conveyance path. The apparatus can include a consumable forming apparatus configured to receive the sheet of aerosol-generating material and form the sheet into a consumable, and a controller configured to determine the presence of a defect in the sheet based on the information detected by the sensor. A consumable for an aerosol provision system can be manufactured by the apparatus and/or method disclosed herein. Additionally, an apparatus, method and controller for analyzing a sheet of aerosol-generating material for an aerosol provision system consumable and a system for manufacturing a consumable for an aerosol provision system.

### PRIORITY CLAIM

The present application is a National Phase entry of PCT Application No. PCT/GB2021/052260, filed Sep. 1, 2021, which claims priority from GB Application No. 2013714.7, filed Sep. 1, 2020, each of which hereby fully incorporated herein by reference.

### TECHNICAL FIELD

The present disclosure relates to an apparatus for manufacturing a consumable for an aerosol provision system and a method of manufacturing a consumable for an aerosol provision system. The present disclosure further relates to a consumable for an aerosol provision system manufactured by the apparatus and/or method disclosed herein. Additionally, the present disclosure relates to an apparatus for analyzing a sheet of aerosol-generating material for an aerosol provision system consumable and a controller for an apparatus for analyzing a sheet of aerosol-generating material. Furthermore, the present disclosure relates to a system for manufacturing a consumable for an aerosol provision system.

### BACKGROUND

Certain tobacco industry products produce an aerosol during use, which is inhaled by a consumer. For example, tobacco-heating devices heat an aerosol-generating material such as tobacco to form an aerosol by heating, but not burning, the substrate. The quality and consistency of the aerosol-generating material is important to the quality of the product and the experience of the consumer when using the product.

### SUMMARY

According to the present disclosure, there is provided an apparatus for manufacturing a consumable for an aerosol provision system, the apparatus comprising: a feeding apparatus for receiving a sheet of aerosol-generating material and configured to supply the sheet of aerosol-generating material along a conveyance path; a sensor configured to detect information indicative of defects in the sheet of aerosol-generating material as the sheet of aerosol-generating material passes along the conveyance path; a consumable forming apparatus configured to receive the sheet of aerosol-generating material and form the sheet of aerosol-generating material into a consumable; and, a controller configured to determine the presence of a defect in the sheet of aerosol-generating material based on the information detected by the sensor.

In some embodiments, the controller is configured to determine the location of the defect in the consumable formed by the consumable forming apparatus based on the information detected by the sensor.

In some embodiments, the location of the defect includes the axial location of the defect along the consumable.

In some embodiments, the controller is configured to determine one or more parameters of the defect and, preferably, the parameters of the defect includes one or more of the: length, width, depth, the angle of the extent of the defect with respect to the direction of the conveyance path, the area of the defect, the density of the sheet, the thickness of the sheet or the porosity of the sheet.

In some embodiments, the defect(s) may be present in one or more discrete regions of the sheet. In other embodiments, the defect may be present in the entire sheet or substantially the entire sheet. For example, the entire sheet may have inadvertently been manufactured such that a parameter of the sheet material deviates from a desired value. The parameter may be one or more of the, the density/thickness/porosity of the sheet material. For example, the density of the sheet material may be lower than desired, which would make it more difficult to reduce the sheet through the apparatus. The sensor may be configured to detect that the sheet material is of reduced density (or that some other parameter deviates from a target value or target range) and the controller may be configured to determine the presence of said defect in the sheet of aerosol-generating material based on the information detected by the sensor.

In some embodiments, the controller is configured to compare the parameter of the defect to pre-set values.

In some embodiments, the controller is configured to classify a defect based on the comparison between parameters of the defect and the pre-set values and, preferably, wherein the classification relates to the severity of the defect.

In some embodiments, the controller is configured to evaluate the quality of the entire sheet of aerosol-generating material based on the quantity or surface density of the one or more defects and/or the classifications of one or more of the defects. In some embodiments, the controller is configured to evaluate the quality of the entire sheet of aerosol-generating material based on the quantity or surface density of the one or more defects within a region and/or the classifications of one or more of the defects within a region. The region could, for example, comprise an end of the sheet material.

In some embodiments, the controller is configured to determine the presence of a defect in at least one discrete region of the sheet of aerosol-generating material based on the information detected by the sensor.

In some embodiments, the controller is configured to determine the presence of a defect present along substantially the entire length of the sheet of aerosol-generating material based on the information detected by the sensor.

In some embodiments, the defect is deviation of at least one parameter of the sheet present along substantially the entire length of the sheet from a target range or value and, preferably, wherein said parameter is one or more of the: thickness, density or porosity of the sheet.

In some embodiments, the controller is configured to evaluate the quality of a region of the sheet of aerosol-generating material based on the quantity or surface density of the one or more defects within said region and/or the classifications of one or more of the defects within said region.

In some embodiments, the evaluation of quality produces a quality metric, and preferably, wherein the controller is configured to store the metric in memory, and preferably wherein the metric is associated with said region.

In some embodiments, the region of the sheet corresponds to aerosol-generating material of a discrete consumable or a batch of discrete consumables formed by the apparatus.

In some embodiments, the controller is configured to perform a particular action dependent on the evaluation of the quality of the region.

In some embodiments, the action comprises sending a signal indicating that the quality of the region is below a predefined value and, preferably, that the region and/or entire sheet material is to be discarded and/or recycled

In some embodiments, the action comprises sending a signal indicating that the consumable or batch of consumables comprising the region is to be sorted from other consumables or batches of consumables formed by the consumable forming apparatus if the evaluation of the quality of the region determines that the quality is below a predefined value and, preferably, that the consumable or batch of consumables comprising the region is to be discarded and/or recycled.

In some embodiments, the sensor comprises a signal transmitter and signal receiver for defect detection and, preferably, the signal is a laser signal.

In some embodiments, the apparatus comprises a plurality of sensors.

In some embodiments, the sensors are configured to detect regions of the sheet that are offset in a direction perpendicular to the direction of the conveyance path and/or are configured to detect regions of the sheet that are offset in a direction along the conveyance path.

In some embodiments, the sensor is configured to determine the topology of at least a portion of the sheet of aerosol-generating material.

In some embodiments, the sensor is located above or below the sheet of aerosol-generating material.

In some embodiments, the sensor comprises a camera.

In some embodiments, the apparatus further comprises an illuminator configured to illuminate the sheet of aerosol-generating material.

In some embodiments, the illuminator is located on a side of the sheet of aerosol-generating material that is distal to the camera.

In some embodiments, the illuminator is located on both sides of the sheet of aerosol-generating material.

In some embodiments, the illuminator comprises a filter.

In some embodiments, the camera comprises a filter and, preferably, the filter is a polarizing filter.

In some embodiments, the filter of the illuminator is configured to pass electromagnetic radiation at least some of which has the same frequency as electromagnetic radiation passed by the filter of the camera.

In some embodiments, the camera is a three-dimensional camera that is configured to detect three-dimensional images of the sheet.

In some embodiments, the defect detected by the sensor include one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

In some embodiments, the thickness, density or porosity of the sheet may be determined by transmitting electromagnetic radiation (for example, visible light) on one side of the sheet and measuring the amount of the electromagnetic radiation (for example, the amount of light) detected on the other side of the sheet. It has been found that a smaller amount of electromagnetic radiation detected on said other side of the sheet is indicative that the sheet is thinner, less dense and/or more porous sheet. In some embodiments, the thickness, density or porosity of the sheet may be detected using an X-ray or microwave sensor. In a yet further embodiment, the thickness, density or porosity of the sheet may be detected using ultrasound.

In some embodiments, the feeding apparatus supplies a continuous sheet of aerosol-generating material and, preferably the feeding apparatus comprises a bobbin receiving mechanism for receiving a bobbin of a sheet of aerosol-generating material and, preferably, the feeding apparatus comprises a bobbin of a sheet of aerosol-generating material.

In some embodiments, the sheet of aerosol-generating material comprises tobacco.

In some embodiments, the consumable forming apparatus comprises a strip forming apparatus that is configured to form the sheet of aerosol-generating material into strips.

In some embodiments, the strip forming apparatus comprises a cutting apparatus configured to cut at least a portion of the sheet of aerosol-generating material into strips of aerosol-generating material.

In some embodiments, the consumable forming apparatus comprises a gathering apparatus configured to gather the strips of aerosol-generating material.

In some embodiments, the consumable forming apparatus comprises a wrapping apparatus configured to wrap the aerosol-generating material in a wrapper.

In some embodiments, the consumable forming apparatus comprises a cutting apparatus for cutting the consumable into discrete consumables.

In some embodiments, the discrete consumables are single-length or double-length consumables.

In some embodiments, the controller is configured to associate a defect with a discrete consumable.

In some embodiments, the controller is configured to associate a defect with a batch of discrete consumables formed by the consumable forming apparatus.

In some embodiments, the apparatus comprises a sorting apparatus configured to remove discrete consumables determined by the controller to comprise one or more defects.

In some embodiments, the consumable is a rod.

According to the present disclosure, there is also provided an apparatus for analyzing a sheet of aerosol-generating material to be formed into a consumable for an aerosol provision system, the apparatus comprising: a sensor configured to detect information indicative of defects in a sheet of aerosol-generating material as the sheet of aerosol-generating material passes along a conveyance path; and, a controller configured to determine the presence of a defect in the sheet of aerosol-generating material based on the information detected by the sensor.

In some embodiments, the apparatus has one or more of the features of the apparatus so described hereinbefore.

According to the present disclosure, there is also provided a controller for an apparatus for analyzing a sheet of aerosol-generating material to be formed into a consumable for an aerosol provision system, the controller configured to connect to a sensor, wherein the sensor is configured to detect information indicative of defects in a sheet of aerosol-generating material, the controller configured to determine the presence of a defect in the sheet of aerosol-generating material based on the information detected by the sensor.

In some embodiments, the sensor is configured to detect information indicative of defects in the sheet of aerosol-generating material as the sheet of aerosol-generating material passes along a conveyance path.

In some embodiments, the controller has one or more of the features of the apparatus described herein.

According to the present disclosure, there is also provided a method of manufacturing a consumable for an aerosol provision system, the method comprising: feeding a sheet of aerosol-generating material along a conveyance path; detecting information indicative of defects in the sheet of aerosol-generating material as the sheet of aerosol-generating material passes along the conveyance path; forming the sheet of aerosol-generating material into a consumable; and, determining the presence of a defect in the consumable based on the detected information.

In some embodiments, the method comprises determining the location of the defect in the formed consumable based on the detected information and, preferably, determining the axial location of the defect.

In some embodiments, the method comprises determining one or more parameters of the defect and, preferably, the parameters of the defect includes one or more of the: length, width, depth, the angle of the extent of the defect with respect to the direction of the conveyance path, the area of the defect, the density of the sheet, the thickness of the sheet or the porosity of the sheet.

In some embodiments, the method comprises comparing the parameter of the defect to one or more pre-set values and, preferably, classifying the defect based on the comparison between parameters of the defect and the one or more pre-set values.

In some embodiments, determining the presence of a defect in the consumable based on the detected information comprises determining the presence of a defect in at least one discrete region of the sheet based on the information detected by the sensor.

In some embodiments, determining the presence of a defect in the consumable based on the detected information comprises determining the presence of a defect present along substantially the entire length of the sheet based on the information detected by the sensor.

In some embodiments, the defect is deviation of at least one parameter of the sheet present along substantially the entire length of the sheet from a target range or value and, preferably, wherein said parameter is one or more of the thickness, density or porosity of the sheet.

In some embodiments, the method comprises using a sensor to detect the information indicative of defects and, preferably, and the sensor comprises a signal transmitter and signal receiver for defect detection.

In some embodiments, the sensor comprises multiple signal transmitters and signal receivers.

In some embodiments, the sensors are configured to detect regions of the sheet that are offset in a direction perpendicular to the direction of the conveyance path and/or are configured to detect regions of the sheet that are offset in a direction along the conveyance path.

In some embodiments, the sensor is located above or below the sheet of aerosol-generating material.

In some embodiments, the sensor comprises a camera and, preferably wherein the camera is a three-dimensional camera that is configured to detect three-dimensional images of the sheet.

In some embodiments, the camera comprises a filter and, preferably, the filter is a polarizing filter.

In some embodiments, the method comprises illuminating the sheet of aerosol-generating material in a region of the sheet detected by the camera.

In some embodiments, the method comprises illuminating the sheet form a side of the sheet that is distal from the camera.

In some embodiments, the method comprises illuminating both sides of the sheet of aerosol-generating material.

In some embodiments, the method comprises illuminating the sheet of aerosol-generating material via a filter configured to filter electromagnetic radiation of the same frequency as the filter of the camera.

In some embodiments, the method comprises determining the topology of at least a portion of the sheet of aerosol-generating material.

In some embodiments, the defect detected includes one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

In some embodiments, feeding a sheet of aerosol-generating material along a conveyance path comprises feeding a continuous sheet of aerosol-generating material and, preferably, the sheet is supplied from a bobbin.

In some embodiments, the sheet of aerosol-generating material comprises tobacco.

In some embodiments, forming the sheet of aerosol-generating material into a consumable comprises forming the sheet of aerosol-generating material into strips and, preferably, comprises cutting at least a portion of the sheet of aerosol-generating material into strips.

In some embodiments, forming the sheet of aerosol-generating material into a consumable comprises gathering the strips of aerosol-generating material.

In some embodiments, forming the sheet of aerosol-generating material into a consumable comprises wrapping the aerosol-generating material in a wrapper.

In some embodiments, forming the sheet of aerosol-generating material into a consumable comprises cutting the consumable into discrete consumables and, preferably, the discrete consumables are single-length or double-length consumables.

In some embodiments, the method comprises associating a defect with a discrete consumable.

In some embodiments, the method comprises sorting discrete consumables determined by the controller to comprise one or more defects from discrete consumables that are not determined by the controller to comprise one or more defects.

In some embodiments, the method comprises associating a defect with a batch of discrete consumables.

In some embodiments, the consumable is a rod.

According to the present disclosure there is also provided a consumable for an aerosol provision system manufactured by the apparatus disclosed herein and/or manufactured by the method disclosed herein.

According to the present disclosure there is also provided an apparatus for analyzing a sheet of aerosol-generating material for an aerosol provision system consumable, the apparatus comprising: a sensor configured to detect information indicative of defects in the sheet of aerosol-generating material; and a controller configured to determine the presence of a defect in the sheet of aerosol-generating material based on the information detected by the sensor.

The controller may be configured to determine one or more parameters of the defect and, preferably, the parameters of the defect may include one or more of the: length, width, depth, the angle of the extent of the defect with respect to the direction of the conveyance path, the area of the defect, the density of the sheet, the thickness of the sheet or the porosity of the sheet.

The controller may be configured to compare the parameter of the defect to pre-set values.

The controller may be configured to classify a defect based on the comparison between parameters of the defect and the pre-set values and, preferably, wherein the classification relates to the severity of the defect.

In some embodiments, the controller is configured to determine the presence of a defect in at least one discrete region of the sheet of aerosol-generating material based on the information detected by the sensor.

In some embodiments, the controller is configured to determine the presence of a defect present along substantially the entire length of the sheet of aerosol-generating material based on the information detected by the sensor.

In some embodiments, the defect is deviation of at least one parameter of the sheet present along substantially the entire length of the sheet from a target range or value and, preferably, wherein said parameter is one or more of the: thickness, density or porosity of the sheet.

The controller may be configured to evaluate the quality of a region of the sheet of aerosol-generating material based on the quantity or surface density of the one or more defects within said region and/or the classifications of one or more of the defects within said region.

The evaluation of quality may produce a quality metric, and preferably, the controller may be configured to store the metric in memory, and preferably the metric may be associated with said region.

The region of the sheet may correspond to aerosol-generating material of a discrete consumable or a batch of discrete consumables formed by the apparatus.

The controller may be configured to perform a particular action dependent on the evaluation of the quality of the region.

The action may comprise sending a signal indicating that the quality of the region is below a predefined value and, preferably, that the region and/or entire sheet material is to be discarded and/or recycled.

The sensor may comprise a signal transmitter and signal receiver for defect detection and, preferably, the signal may be a laser signal.

The apparatus may comprise a plurality of sensors.

The sensor may be configured to determine the topology of at least a portion of the sheet of aerosol-generating material.

The sensor may comprise a camera.

The apparatus may further comprise an illuminator configured to illuminate the sheet of aerosol-generating material.

The illuminator may be configured to be located on a side of the sheet of aerosol-generating material that is distal to the camera.

The illuminator may be configured to be located on both sides of the sheet of aerosol-generating material.

The illuminator may comprise a filter.

The camera may comprise a filter and, preferably, the filter may be a polarizing filter.

The filter of the illuminator may be configured to pass electromagnetic radiation at least some of which has the same frequency as electromagnetic radiation passed by the filter of the camera.

The camera may be a three-dimensional camera that is configured to detect three-dimensional images of the sheet.

The defect detected by the sensor may include one or more of holes, slits, non-so uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

The sheet of aerosol-generating material may comprise tobacco.

According to the present disclosure there is also provided an apparatus for manufacturing a consumable for an aerosol provision system, the apparatus comprising: the apparatus disclosed herein for analyzing a sheet of aerosol-generating material; a feeding apparatus for receiving a sheet of aerosol-generating material and configured to supply the sheet of aerosol-generating material along a conveyance path; and, a consumable forming apparatus configured to receive the sheet of aerosol-generating material and form the sheet of aerosol-generating material into a consumable.

The consumable forming apparatus may comprise a strip forming apparatus that is configured to form the sheet of aerosol-generating material into strips.

The strip forming apparatus may comprise a cutting apparatus configured to cut at least a portion of the sheet of aerosol-generating material into strips of aerosol-generating material.

The consumable forming apparatus may comprise a gathering apparatus configured to gather the strips of aerosol-generating material.

The consumable forming apparatus may comprise a wrapping apparatus configured to wrap the aerosol-generating material in a wrapper.

The consumable forming apparatus may comprise a cutting apparatus for cutting the consumable into discrete consumables.

The discrete consumables may be single-length or double-length consumables.

The controller may be configured to associate a defect with a discrete consumable.

The controller may be configured to associate a defect with a batch of discrete consumables formed by the consumable forming apparatus.

The apparatus may comprise a sorting apparatus configured to remove discrete consumables determined by the controller to comprise one or more defects.

The consumable may be a rod.

The controller may be configured to determine the location of the defect in the consumable formed by the consumable forming apparatus based on the information detected by the sensor.

The location of the defect may include the axial location of the defect along the consumable.

The controller may be configured to perform a particular action dependent on the evaluation of the quality of the region.

In some embodiments, the action comprises sending a signal indicating that the quality of the region is below a predefined value and, preferably, that the region and/or entire sheet material is to be discarded and/or recycled.

In some embodiments, the action comprises sending a signal indicating that the consumable or batch of consumables comprising the region is to be sorted from other consumables or batches of consumables formed by the consumable forming apparatus if the evaluation of the quality of the region determines that the quality is below a predefined value and, preferably, that the consumable or batch of consumables comprising the region is to be discarded and/or recycled.

The sensor may be located above or below the sheet of aerosol-generating material.

The feeding apparatus may supply a continuous sheet of aerosol-generating material and, preferably the feeding apparatus may comprise a bobbin receiving mechanism for receiving a bobbin of a sheet of aerosol-generating material and, preferably, the feeding apparatus may comprise a bobbin of a sheet of aerosol-generating material.

The sensor may be configured to detect information indicative of defects in the sheet of aerosol-generating material as the sheet of aerosol-generating material passes along the conveyance path.

The apparatus for analyzing a sheet of aerosol-generating material may comprise a plurality of sensors that are configured to detect regions of the sheet that are offset in a direction perpendicular to the direction of the conveyance path and/or are configured to detect regions of the sheet that are offset in a direction along the conveyance path.

The sensor may be configured to detect information indicative of defects in the sheet of aerosol-generating material prior to the feeding apparatus receiving the sheet.

According to the present disclosure, there is also provided a controller for an apparatus for analyzing a sheet of aerosol-generating material to be formed into a consumable for an aerosol provision system, the controller configured to connect to a sensor, wherein the sensor is configured to detect information indicative of defects in a sheet of aerosol-generating material, the controller configured to determine the presence of a defect in the sheet of aerosol-generating material based on the information detected by the sensor.

The sensor may be configured to detect information indicative of defects in a sheet of aerosol-generating material as the sheet of aerosol-generating material passes along a conveyance path.

The sensor may be configured to detect information indicative of defects in a sheet of aerosol-generating material prior to the sheet of aerosol-generating material being fed along a conveyance path.

The apparatus/controller may have any of the features disclosed herein.

According to the present disclosure, there is also provided a method of analyzing a sheet of aerosol-generating material for an aerosol provision system consumable, the method comprising: detecting information indicative of defects in the sheet of aerosol-so generating material; and determining the presence of a defect in the consumable based on the detected information.

The method may comprise determining one or more parameters of the defect and, preferably, the parameters of the defect may include one or more of the: length, width, depth, the angle of the extent of the defect with respect to the direction of the conveyance path, the area of the defect, the density of the sheet, the thickness of the sheet or the porosity of the sheet.

The method may comprise comparing the parameter of the defect to one or more pre-set values and, preferably, may comprise classifying the defect based on the comparison between parameters of the defect and the one or more pre-set values.

In some embodiments, determining the presence of a defect in the consumable based on the detected information comprises determining the presence of a defect in at least one discrete region of the sheet based on the information detected by the sensor.

In some embodiments, determining the presence of a defect in the consumable based on the detected information comprises determining the presence of a defect present along substantially the entire length of the sheet based on the information detected by the sensor.

In some embodiments, the defect is deviation of at least one parameter of the sheet present along substantially the entire length of the sheet from a target range or value and, preferably, wherein said parameter is one or more of the thickness, density or porosity of the sheet.

The method may comprise feeding the sheet along a conveyance path and detecting information indicative of defects as the sheet is fed along the conveyance path.

The method may comprise using a sensor to detect the information indicative of defects and, preferably, and the sensor may comprise a signal transmitter and signal receiver for defect detection.

The sensor may comprise multiple signal transmitters and signal receivers.

The sensor may comprise a camera and, preferably, the camera may be a three-dimensional camera that is configured to detect three-dimensional images of the sheet.

The camera may comprise a filter and, preferably, the filter is a polarizing filter.

The method may comprise illuminating the sheet of aerosol-generating material in a region of the sheet detected by the camera.

The method may comprise illuminating the sheet from a side of the sheet that is distal from the camera.

The method may comprise illuminating both sides of the sheet of aerosol-generating material.

The method may comprise illuminating the sheet of aerosol-generating material via a filter configured to filter electromagnetic radiation of the same frequency as the filter of the camera.

The method may comprise determining the topology of at least a portion of the sheet of aerosol-generating material.

The defect detected may include one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

The sheet of aerosol-generating material may comprise tobacco.

According to the present disclosure, there is also provided a method of manufacturing a consumable for an aerosol provision system, the method comprising analyzing a sheet of aerosol-generating material for an aerosol provision system as described herein and forming the sheet of aerosol-generating material into a consumable.

The method may comprise feeding a sheet of aerosol-generating material along a conveyance path.

The method may comprise determining the location of the defect in the formed consumable based on the detected information and, preferably, may comprise determining the axial location of the defect.

The sensor may be located above or below the sheet of aerosol-generating material.

Feeding a sheet of aerosol-generating material along a conveyance path may comprise feeding a continuous sheet of aerosol-generating material and, preferably, the sheet may be supplied from a bobbin.

Detecting information indicative of defects in the sheet of aerosol-generating material may comprise detecting information indicative of defects in the sheet of aerosol-generating material as the sheet of aerosol-generating material passes along the conveyance path.

The method may comprise using a plurality of sensors to detect the information indicative of defects and, preferably, the sensors may be configured to detect regions of the sheet that are offset in a direction perpendicular to the direction of the conveyance path and/or are configured to detect regions of the sheet that are offset in a direction along the conveyance path.

Feeding a sheet of aerosol-generating material along a conveyance path may comprise detecting information indicative of defects in the sheet of aerosol-generating material prior to sheet being fed along the conveyance path and, preferably, prior to the sheet material being received by a feeding apparatus.

Forming the sheet of aerosol-generating material into a consumable may comprise forming the sheet of aerosol-generating material into strips and, preferably, may comprise cutting at least a portion of the sheet of aerosol-generating material into strips.

Forming the sheet of aerosol-generating material into a consumable may comprise gathering the strips of aerosol-generating material.

Forming the sheet of aerosol-generating material into a consumable may comprise so wrapping the aerosol-generating material in a wrapper.

Forming the sheet of aerosol-generating material into a consumable may comprise cutting the consumable into discrete consumables and, preferably, the discrete consumables may be single-length or double-length consumables.

The method may comprise associating a defect with a discrete consumable.

The method may comprise sorting discrete consumables determined by the controller to comprise one or more defects from discrete consumables that are not determined by the controller to comprise one or more defects.

The method may comprise associating a defect with a batch of discrete consumables.

The consumable may be a rod.

According to the present disclosure, there is also provided a consumable for an aerosol provision system manufactured by the apparatus disclosed herein and/or manufactured by the method disclosed herein.

According to the present disclosure, there is also provided a system for manufacturing a consumable for an aerosol provision system, the system for manufacturing a consumable comprising: an apparatus disclosed herein for analyzing a sheet of aerosol-generating material for an aerosol provision system consumable; a feeding apparatus for receiving a sheet of aerosol-generating material and configured to supply the sheet of aerosol-generating material along a conveyance path; and, a consumable forming apparatus configured to receive the sheet of aerosol-generating material and form the sheet of aerosol-generating material into a consumable.

The system may have any of the features of the apparatus for analyzing the sheet, the feeding apparatus and/or the consumable forming apparatus disclosed herein.

### BRIEF DESCRIPTION OF THE DRAWINGS

Embodiments will now be described, by way of example only, with reference to the accompanying drawings, in which:

FIG. 1 is a schematic drawing of an embodiment of an apparatus for manufacturing a consumable for an aerosol provision system;

FIG. 2 is a schematic drawing of a sheet of material being formed into a consumable;

FIG. 3 is a schematic drawing of a sensor and a controller of the apparatus of FIG. 1;

FIG. 4 is a schematic drawing of the sheet of material passing an embodiment of a sensor;

FIG. 5 is a schematic top view of a portion of the sheet of material, wherein a defect is being detected by the sensor of FIG. 4;

FIG. 6 is a schematic drawing of the sheet of material passing another embodiment of a sensor;

FIG. 7 is a schematic top view of a portion of the sheet of material, wherein a defect is being detected by the sensor of FIG. 6;

FIG. 8 is a schematic cross-sectional view of an aerosol provision system comprising a consumable manufactured by the apparatus of FIG. 1;

FIG. 9 is a flow diagram of an embodiment of a method of manufacturing a consumable for an aerosol provision system; and,

FIG. 10 is a flow diagram of another embodiment of a method of manufacturing a consumable for an aerosol provision system.

### DETAILED DESCRIPTION

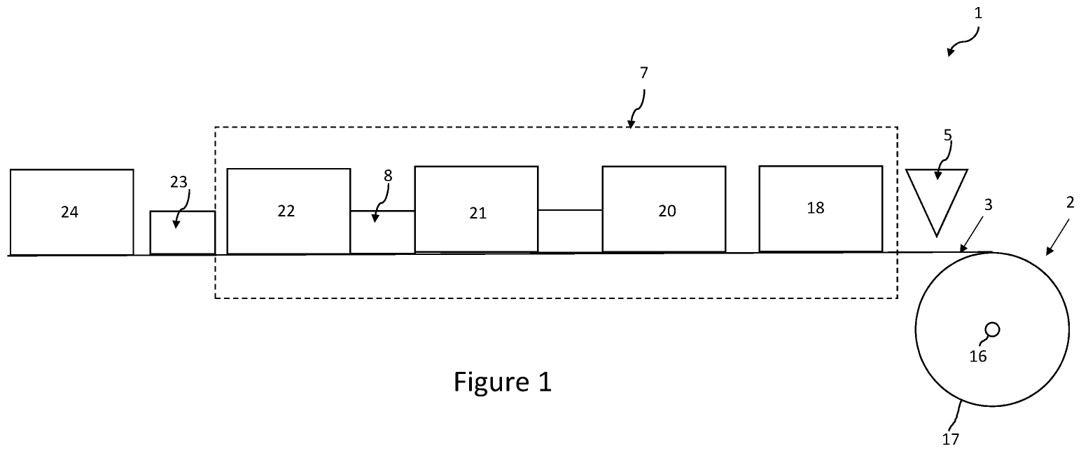

FIG. 1 shows a schematic diagram of an embodiment of an apparatus 1 for manufacturing a consumable for use in an aerosol provision system.

In the present example, the consumable is a rod of aerosol-generating material. However, it should be recognized that in alternative embodiments the consumable may have a different configuration, for example, being a strip of aerosol-generating material.

The apparatus 1 comprises a feeding apparatus 2 which receives a supply of a sheet 3 of aerosol-generating material and is configured to supply the sheet 3 of aerosol-generating material as a continuous web along a conveyance path 4.

The aerosol-generating material is a tobacco material, for example, a reconstituted tobacco material that is formed into a continuous web. However, it should be recognized that the aerosol-generating material may alternatively be a non-tobacco material.

The apparatus 1 further comprises a sensor 5 configured to detect information indicative of defects 6 in the sheet 3 of aerosol-generating material as the sheet 3 of aerosol-generating material passes along the conveyance path 4.

The apparatus 1 also comprises a consumable forming apparatus 7 configured to receive the sheet 3 of aerosol-generating material and form the sheet 3 into a consumable. In the present example, the consumable forming apparatus 7 is a rod forming apparatus 7 configured to receive the sheet 3 of aerosol-generating material and to form the sheet 3 of aerosol-generating material into a rod. In the present example, the rod forming apparatus 7 is configured to form the sheet 3 into a continuous rod 8 that is then cut into discrete rods 23.

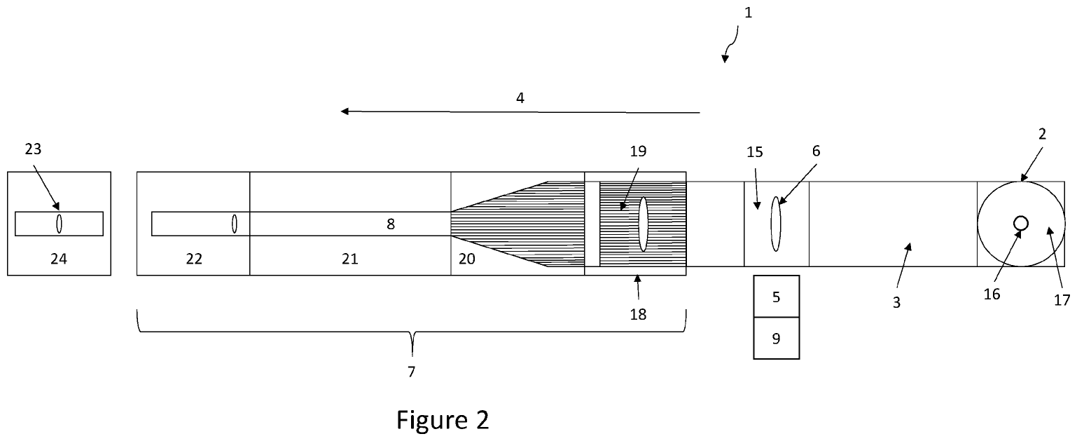

FIG. 2 schematically shows the sheet 3 of aerosol-generating material being formed into a consumable 8, which in the present example is a discrete rod 23.

The sensor 5 is configured to detect defects 6 in the sheet 3 of aerosol-generating material prior to the sheet 3 of aerosol-generating material being formed into a rod 8 by the rod forming apparatus 7. In the present example, the sensor 5 is located between the feeding apparatus 2 and the rod forming apparatus 7. In other words, the rod forming apparatus 7 is downstream of the sensor 5 and the sensor 5 is downstream of the feeding apparatus 2. The term “downstream” refers to the direction of the sheet 3 along the conveyance path 4 as the sheet 3 of aerosol-generating material travels from the feeding apparatus 2, past the sensor 5, towards the rod forming apparatus 7. This embodiment may be referred to as ‘online’ inspection since the sheet of material 3 is inspected whilst it is conveyed by the feeding apparatus 2 along the conveyance path 4.

In some embodiments, an apparatus for detecting the defect is provided comprising the sensor 5 and the controller 9. In one embodiment, an apparatus for detecting a defect is provided that optionally further comprises a feeding apparatus for feeding the sheet 3 along a conveyance path.

The apparatus 1 for manufacturing the consumable may comprise the apparatus for detecting the defect. In other embodiments, the apparatus for detecting the defect may be separate and distinct to the apparatus 1 for manufacturing the consumable and, for example, may be used to detect defects in at least a portion of the sheet 3 (e.g. an end of the sheet 3 or the entire sheet 3) prior to the sheet 3 being processed by the apparatus 1 for manufacturing consumables.

In some embodiments, the sheet 3 of aerosol-generating material may be inspected by the sensor 5 and then, if the sheet 3 is deemed to be of sufficient quality, the sheet 3 is then fed along the conveyance path 4. Once the sheet has been deemed acceptable by a controller (described in more detail below), the feeding apparatus 2 can be initiated to feed the sheet 3 along the conveyance path 4 and begin the rod forming process. For example, an end the sheet of material 3 may be inspected prior to the sheet of material 3 being loaded into the apparatus 1, or after loading the sheet of material 3 into the apparatus 1. This may be referred to as ‘offline’ inspection since the sheet of material 3 is inspected prior to the feeding apparatus 2 conveying the sheet of material 3 along the conveyance path 4.

As shown in FIG. 1, the feeding apparatus 2 comprises a receiving mechanism 16 which receives a supply 17 of a sheet 3 of aerosol-generating material. In the present example, the receiving mechanism 16 is configured to receive a bobbin 17 of a sheet 3 of aerosol-generating material. The bobbin 17 supplies a continuous web of the sheet 3 of aerosol-generating material along the conveyance path 4. In an alternative embodiment (not shown), the feeding apparatus 2 supplies individual sheets of aerosol-generating material along the conveyance path 4.

The sheet 3 may be fed along the conveyance path 4 by any suitable mechanism, for example, a belt or a plurality of rollers.

The rod forming apparatus 7 comprises a cutting or shredding apparatus 18 which is configured to cut at least a portion or the whole width of the sheet 3 of aerosol-generating material into strips 19 of aerosol-generating material.

The rod forming apparatus 7 also comprises a gathering apparatus 20 configured to gather the strips 19 of aerosol-generating material produced by the cutting apparatus 18 into a rod shape. In the present example, the rod has a generally circular shaped cross-section. However, it should be recognized that in other embodiments (not shown) the so rod may have an alternative shape, for example, being tubular, oval, square or hexagonal.

The gathering apparatus 20 may comprise a funnel or cone (not shown) that is configured to gather the strips 19 together such that the strips 19 exit the funnel or cone as a rod.

The rod forming apparatus 7 further comprises a wrapping apparatus 21, downstream of the gathering apparatus 20, configured to wrap the gathered strips 19 of aerosol-generating material in a wrapper.

The wrapping apparatus 21 comprises a garniture (not shown) that is configured to receive the rod of gathered strips 19 and wrap the strips 19 in the wrapper. The wrapper may be fed as a continuous web through the garniture on a garniture belt (not shown) that is configured to wrap around the rod of strips 19 as the belt, wrapper and strips 19 pass through a narrowing cone or tongue of the garniture. The wrapper may then be secured in position using adhesive that is applied or pre-applied to an edge of the wrapper. It should be recognized that in alternative embodiments the wrapping apparatus 21 may be of an alternate configuration, for example, comprising a wrapping drum that wraps the wrapper about the rod of strips 19.

In the example of FIG. 1, the strips 19 are gathered by the gathering apparatus 20 and then the gathered strips 19 are passed to the wrapping apparatus 21. However, in an alternative embodiment (not shown), a combined gathering and wrapping apparatus gathers the strips 19 into a rod and wraps the strips 19 in a wrapper. For instance, the strips 19 could be fed into a garniture that gathers the strips 19 into a rod and simultaneously wraps the rod in a wrapper.

The rod forming apparatus 7 comprises a cutting apparatus 22 that is downstream of the wrapping apparatus 21 and is configured to cut the continuous wrapped rod 8 into discrete rods 23 of aerosol-generating material. The discrete rods 23 produced by the cutting apparatus 22 may be single-length or double-length rods, or longer.

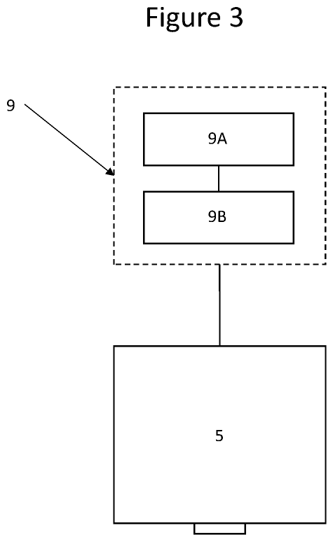

The apparatus 1 comprises a controller 9 (shown in FIG. 3) configured to determine the presence of a defect 6 in a rod 23 formed by the rod forming apparatus 7 based on the information detected by the sensor 5. The controller 9 is configured to associate a defect 6 with a discrete rod 23 cut by the cutting apparatus 22.

Alternatively, or additionally, the controller 9 is configured to associate a defect 6 with a batch of discrete rods 23 produced by the rod forming apparatus 7. For example, if a defect 6 is detected by the sensor 5 then the controller 9 may determine that a batch of discrete rods 23 comprises the defect 6 (for example, a batch of two, three, four, five, six, seven, eight, ten, twenty, fifty or one-hundred rods). The entire batch comprising the defect may then be collected/discarded or otherwise sorted from the remaining batches of rods 23 that do not comprise defects. Furthermore, the controller 9 may be configured to associate a defect 6 with the type of sheet material being supplied along the conveyance path 4. For example, the controller 9 may be configured to associate the defect 6 with a particular brand or manufacturer of sheet material or a sheet material with particular properties, such as a particular thickness/width/composition of sheet material. That is, the controller 9 may be configured to log that a particular type of sheet material is more prone to defects 6. For instance, that a sheet material manufactured by a particular manufacturer is more prone to having defects and/or defects of a greater number and/or severity.

In some embodiments, if the controller 9 detects that a region of the sheet 3 does not meet one or more quality standards (e.g. the sheet being of a density, thickness or porosity that deviates from a target value or range), then the controller 9 determines that the entire length or substantially the entire length of the sheet 3 (for example, all of the sheet 3 on the bobbin) does not meet said one or more quality standards. Therefore, this may be signalled to the operator such that the entire bobbin of sheet 3 is rejected. This may happen ‘offline’ (e.g. before the sheet 3 is loaded on to the feeding apparatus 2) or ‘online’ (e.g. as the sheet 3 passes along the conveyance path after loading on to the feeding apparatus 2). This can help to prevent the apparatus 1 being operated with defected sheet material 3 that would otherwise cause sub-optimal operation of the apparatus 1 (for example, the apparatus being jammed due to the sheet material having insufficient tension or the sheet material breaking/tearing in the apparatus 1).

The controller 9 may trigger an alarm (for example, an audible or visual alarm) if a defect is detected, for example, detected in a rod 23 so that the rod 23 with the defect can be removed from the production line and disposed of. In some embodiments, such disposal may be automatic, for instance, the apparatus 1 may further comprise a sorting apparatus 24 as discussed in more detail below.

In some embodiments, if a defect 6 is detected, the controller 9 is configured to determine the location and/or parameters of the defect 6 in the sheet 3. The dimensions and position of the defect in the sheet 3 can be extrapolated to determine the dimensions and position of the defect within the formed rod. For example, the axial location of the defect 6 along the rod 8 can be determined. As used herein, the term ‘axial location’ refers to the location of the defect along the longitudinal axis of the rod, in other words, in a direction parallel to the conveyance path 4.

Determining the location of the defect 6 is particularly advantageous if the rod forming apparatus 7 is configured to manufacture a discrete rod 23 that is of multiple-lengths, for example, a rod that is two, three, four, five, six, seven or eight times the length of a single-length rod. This is because then only the section of the discrete rod 23 that comprises the defect 6 is removed. In some embodiments, the controller 9 is configured to determine the location of the defect 6 in the rod 8 based on the position of the defect 6 along the width and/or length of the sheet 3.

The parameters of the defect 6 determined by the controller 9 may include one or more of the length, width, depth, area, and density of the defect. Once the defect 6 is identified and measured, the controller 9 is configured to compare the parameters of the defect 6 to one or more pre-set values. This indicates the extent of the defect 6 and a decision can be made by the controller 9 on whether or not to remove the section of rod 8 containing the defect 6, for example, by removing the discrete rod 23 cut by the cutting apparatus 22 that has the defect 6.

The controller 9 is configured to classify a defect 6 based on the comparison between the measured parameters and the pre-set values. This classification may indicate the severity of the defect and therefore the defect's potential degradation to the quality of a consumable. For example, a hole is identified by the sensor 5 and the dimensions of the hole are calculated. The dimensions of the hole may be one or more of the length, width, radius or surface area of the hole. For instance, the severity of the defect 6 may be classified based on the size of the hole detected, with a larger hole indicating a more severe defect 6. Additionally, or alternatively, the severity of the defect 6 may be classified based on the number of abnormalities within a given surface area, the depth of the defect 6, the density of the sheet 3, and/or the angle that a rip or tear extends in the sheet relative to the direction of the conveyance path 4.

In the example that the defect is a hole, the controller 9 may compare the size of the hole 6 to pre-set values of hole dimensions that would classify the hole large enough to be considered a defect. If the dimensions of the hole 6 meet the defect classification criteria, the discrete rod 23 comprising the hole 6 can be removed by the apparatus 1.

For example, a single hole with dimensions that exceed a user defined size could be classified as a defect. Additionally, a group of holes whose combined area exceeds a user defined limit within a user defined boundary can be classified as a defect.

In some embodiments, the parameter of the defect 6 determined by the controller 9 includes the angle of the extent of the defect 6 with respect to the direction of the conveyance path 4. For example, if the sensor 5 detects an abnormality such as a thin hole or tear then the controller 9 may determine the angle that the tear extends with respect to the direction of the conveyance path 4. The controller 9 may, for example, classify the tear as a defect 6 if the angle that the tear extends with respect to the direction of the conveyance path 4 exceeds a predetermined value. This is advantageous because otherwise such a tear may cause separation of the strips 19 when the sheet 3 is processed into strips 19 by the rod forming apparatus 7. In some embodiments, the classification may be based on a function of the angle of the tear with respect to the direction of the conveyance path 4 and the length of the tear. That is, if the angle or length exceeds a predetermined value then the tear is classified as a defect 6.

The controller 9 comprises a memory 9A and a processor 9B. The memory 9A is configured to store instructions and the processor 9B is configured to carry out the instructions.

In some embodiments, the apparatus 1 comprises a sorting apparatus 24 for removing discrete rods 23 determined by the controller 9 to comprise one or more defects 6, or for removing batches of discrete rods 23 wherein one or more of the discrete rods 23 of the batch is determined to comprise one or more defects 6. That is, once the sensor 5 has detected an abnormality in the sheet 3 that is classified by the controller 9 as being a defect 6, as the sheet 3 moves along the conveyance path 4 towards the rod forming apparatus 7, the controller 9 determines which discrete rod 23 the defect 6 will end up in based on the rate of the sheet 3 passing through the apparatus 1. This allows for the defect 6 to be removed from the production line without stopping the apparatus 1 and manually removing the section of sheet 3 comprising the defect 6.

The quality of the sheet 3 of aerosol-generating material can also be evaluated based on the number of defects 6 found in the sheet 3, and/or the classification of said defects. In some embodiments, the controller 9 is configured to make an evaluation of the quality of (e.g. a portion of) the sheet 3 of aerosol-generating material, by evaluating both the quantity, or density (e.g. surface density) of the defects, and the classification of the defects. For example, a portion of the sheet 3 having numerous low-severity defects may be evaluated as being of low quality, or a portion of the sheet having only one high-severity defect may also be evaluated as being of low quality. In some embodiments, each defect may be assigned a weighting based on the severity of the defect. The controller 9 then adds the weighting of all of the defects detected in the sheet 3 or detected within a given area of the sheet, and determines the quality of the sheet accordingly.

For example, in one embodiment a low severity defects are assigned a weighting of 1, the medium severity defects are assigned a weighting of 2, whereas high severity defects are assigned a weighting of 3. In such an example, if the controller 9 detects two high severity defects then the sheet 3/portion of the sheet 3 would be given a quality value of 6. In contrast, if the controller 9 detects two low severity defects and one medium severity defect then the sheet 3/portion of the sheet 3 would be given a quality value of 4, and thus evaluated as of being higher quality than the first example despite the presence of more defects.

In some embodiments, the controller 9 is configured to make an evaluation of the quality of (e.g. a portion of) the sheet 3 of aerosol-generating material, wherein the evaluation of the quality is a function of both the severity of the defects and the number of defects.

In some embodiments, the controller 9 may be configured to count the number of defects 6 detected by the sensor 5 in a given area or length of sheet 3. If the number of defects 6 exceeds a predetermined value and/or if severe defects 6 are detected, then the section of sheet 3 may be removed, for example, by removing the discrete rod 23 comprising said section. 1o In some embodiments, if the controller 9 determines that an entire region of the sheet 3 is defected (for example, is of a thickness, density or porosity outside a target range or value), then it is determined that the entire sheet 3 should be rejected.

The sorting apparatus 24 may comprise, for example, a pusher (not shown) such as a rod that is configured to remove discrete rods 23 that are determined to have defects 6. However, in alternative embodiments the sorting apparatus 24 may remove defected rods 23 by other means, for example, using suction or blowing compressed gas on to the defected rods 23. In some embodiments, the sorting apparatus 24 includes a sorting drum (not shown) that is configured to separate defected rods 23 from rods 23 that are not determined to comprise defects.

The sensor 5 is configured to detect information indicative of defects 6 in the sheet 3 of aerosol-generating material as the sheet 3 of aerosol-generating material passes along the conveyance path 4.

The defects 6 detected by the sensor 5 may include one or more of holes, slits, non-uniformity in the thickness of the sheet, areas of reduced density, voids, tears and lumps. The sensor 5 can also determine the topology of the sheet 3 of aerosol-generating material and therefore can detect non-uniformity in the thickness of the sheet 3. It is to be appreciated that the defects 6 detected may not be in specific regions of the sheet 3 but may be defects 6 in the entire sheet 3. For example, the sensor 5 is configured to detect a defect 6 in the whole sheet 3 such as the density, porosity, thickness or topology of the sheet 3. In some embodiments, a region of the sheet 3 (for example, an end region such as the first 10 or 20 cm of the length of the sheet 3) may be inspected, either online or offline, and the data obtained from the inspection is used to assess the quality of the entire sheet 3. For example, if an end of the sheet 3 is inspected and found have a low density, the entire sheet 3 may be rejected and discarded.

The presence of defects 6 in the sheet 3 of aerosol-generating material is undesirable since this reduces the consistency and/or quality of the final product. It is therefore advantageous to detect defects 6 in the sheet 3 of aerosol-generating material so that defected rods 23 can be removed. A defected rod is a rod that the controller has determined is to be discarded based upon the controller's evaluation of the number of defects and/or the classification of said defects of the rod, in embodiments by so evaluating the quality of the sheet material from which the rod is formed to be of low quality as discussed above. The sensor 5 is arranged so that the defects 6 are detected prior to the sheet 3 of aerosol-generating material being formed into a rod 8. This may allow for a more accurate defect detection in comparison to trying to detect defects after the sheet 3 has been manipulated into a rod.

Furthermore, a defect in the sheet 3 of aerosol-generating material could be detrimental to the various parts of the apparatus 1. The controller 9 may therefore be configured to sound an alarm or shut-down the apparatus 1 if a defect is detected in the sheet 3 of material that could be detrimental to the apparatus 1. For instance, if a defect is detected that is of a configuration that may cause jamming of the apparatus 1, then an alarm may be activated and/or the apparatus 1 may be shut down. For instance, if the defect is of sufficient width to cause the strips 19 to become separated during cutting or shredding of the sheet 3.

In another embodiment, an apparatus for detecting a defect in a sheet comprising the controller and sensor may be provided. In some embodiments the apparatus for detecting a defect may be separate and distinct to the apparatus 1 for manufacturing the consumable. For example, the apparatus for detecting defects may be used to detect defects in at least a portion of the sheet 3 (e.g. an end of the sheet 3 or the entire sheet 3) prior to the sheet 3 being processed by the apparatus 1 for manufacturing consumables. If the sheet 3 is determined to not be of sufficient quality, then the operator is notified via an indication (e.g. an alarm). Thus, the defected sheet 3 is not loaded into the apparatus 1 for manufacturing the consumable.

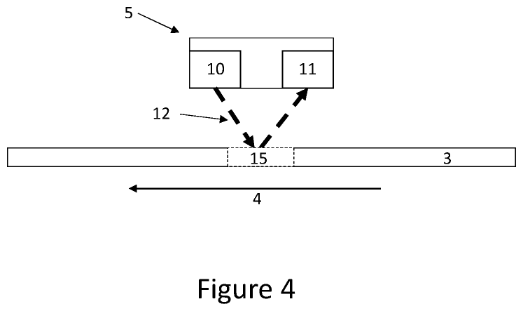

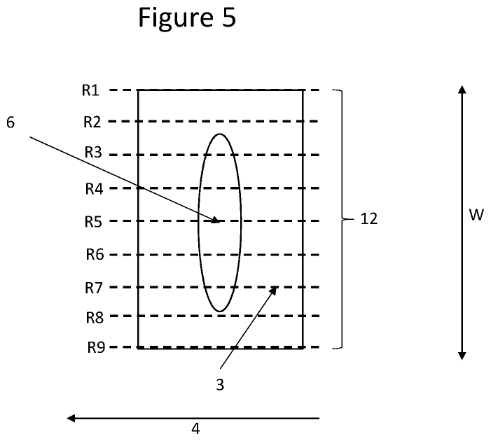

FIGS. 4 and 5 illustrate an embodiment of a sensor 5. The sensor 5 comprises a signal transmitter 10 and a signal receiver 11 for detecting a defect 6.

It should be recognized that other sensors may be used, including sensors that detect any frequency of electromagnetic radiation, such a x-rays, ultraviolet, visible light, infrared or microwaves. In some embodiments, the sensor is an ultrasonic sensor, or an electric and/or magnetic sensor, and may include be a capacitive or inductive sensor.

The sensor 5 is located above a region 15 of the sheet 3 of aerosol-generating material to be scanned by the sensor 5. As the sheet 3 of aerosol-generating material is conveyed along the conveyance path 4, the signal transmitter 10 emits signals 12 directed at an angle towards the sheet 3 of aerosol-generating material. The signals 12 are reflected off the sheet 3 of aerosol-generating material and are received by the signal receiver 11. In the case where the signal receiver 11 does not receive the signal 12 emitted from the signal transmitter 10, this would suggest that the sheet 3 of aerosol-generating material comprises a hole. Optionally, the signals may be laser signals.

The sensor 5 scans the sheet 3 of aerosol-generating material as it passes along the conveyance path 4. The sensor 5 may be digital or analogue. The sensor 5 may transmit and/or receive a continuous or discrete signal.

In some embodiments, there may be multiple sensors 5, each comprising a transmitter and receiver.

In some embodiments, the plurality of sensors 5 are configured to detect regions of the sheet that are offset in a direction along the conveyance path, for example, being arranged sequentially in a direction of the conveyance path 4. Having multiple sensors arranged sequentially allows for a larger region of the sheet 3 of aerosol-generating material to be scanned. Such a configuration also provides a level of redundancy in the event that one of the sensors 5 fails to detect a defect, for instance, due to the speed of the sheet 3 travelling along the conveyance path 4. If a first sensor misses the defect then a second sensor located downstream of the first sensor along the conveyance path can detect the defect. This arrangement also allows for the length of the defect 6 to be determined, by counting the number of longitudinally arranged sensors 5 that simultaneously detect a defect 6. However, another option for determining the length of a defect 6 would be to measure how long a defect 6 is detected for by a specific sensor 5 (or by the sensor 5 in embodiments wherein the apparatus 1 comprises a single sensor 5).

Alternatively, or additionally, in some embodiments the plurality of sensors 5 may be offset in a direction perpendicular to the conveyance path 4. That is, the sensors 5 are configured to detect different regions across the width (see arrow ‘W’ in FIG. 5) of the sheet 3. This arrangement is shown in FIG. 5, wherein each of the dashed-lines R1 to R9 represents a sensing region of a respective sensor 5. This helps to determine the size of the defect. For example, the width of the defect 6 can be determined from the number of sensors 5 that detect a defect 6 simultaneously or within a given time period.

However, it should be recognized that in alternative embodiments a single sensor 5 may be provided that only scans a portion of the width W of the sheet 3 or scans the entire width W of the sheet 3.

In the above embodiment, the sensors 5 may be arranged sequentially in a line that is perpendicular to the conveyance path 4 or at an angle to the conveyance path 4.

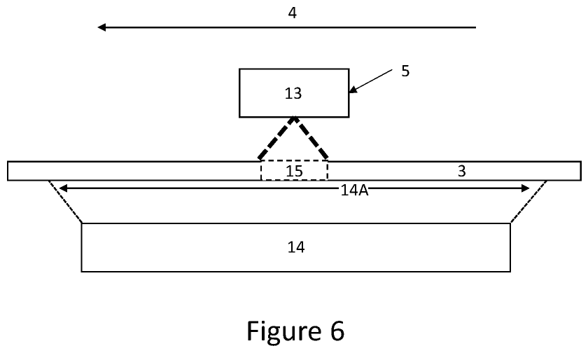

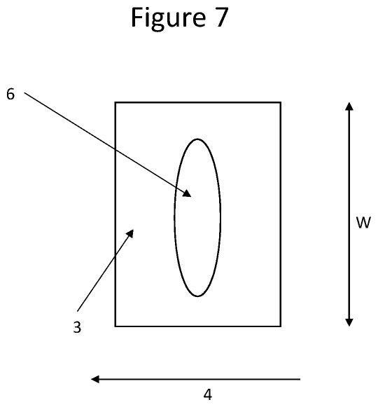

In another embodiment, as depicted in FIGS. 6 and 7, the sensor 5 comprises a camera 13.

It is to be appreciated that any suitable model of camera 13 can be used, for example, the Keyence™ CA-HL02MX camera.

The camera 13 is located above the sheet 3 of aerosol-generating material and is configured to image the sheet 3 of aerosol-generating material as it passes along the conveyance path 4. It is to be appreciated that the camera 13 could also be located below the sheet 3 of aerosol-generating material, or a camera 13 may be provided on each side of the sheet 3.

In some embodiments, the camera 13 is a three-dimensional camera. This helps the camera 13 to detect non-uniformity in the thickness of the sheet 3 of aerosol-generating material.

The camera 13 may comprise a filter (not shown), such as a polarizing filter, which improves the camera's ability to detect defects 6. In some embodiments, the filter of the camera 13 is configured to filter electromagnetic radiation of certain frequencies, for example, higher or lower than a predetermined value. The filter may be a high pass, low pass, or band pass filter.

The apparatus 1 further comprises an illuminator 14 configured to illuminate the sheet 3 of aerosol-generating material.

The illuminator 14 is configured to illuminate a region 14A of the sheet 3. The illuminator 14 is configured to illuminate one or both sides of the sheet 3 in a region 14A that is aligned with the region 15 detected by the camera 14 in the direction of the conveyance path 4. That is, the illuminator 14 may illuminate the reverse of the sheet 3 to the region 15 detected by the camera 13 and/or may illuminate the same side of the so sheet 3 as the region 15 detected by the camera 13.

In some embodiments, the region 14A of the sheet 3 that is illuminated by the illuminator 14 overlies the region 15 of the sheet 3 that is detected by the camera 13 in the direction of the conveyance path 4.

In some embodiments, the illuminator 14 is configured to illuminate the part of the length of sheet 3 that is detected by the camera 13.

The illuminator 14 may comprise a source of electromagnetic radiation, for example, a light source such as a bulb. The illuminator 14 may be configured to focus the electromagnetic radiation towards the sheet 3.

The source of electromagnetic radiation may be directed at the sheet such that more than 5%, 10%, 20%, 30%, 40%, 50%, 60%, 70%, 80% 90%, or 95% of the electromagnetic radiation, or electromagnetic radiation of a particular frequency or range of frequencies, emitted by the illuminator 14 illuminates the sheet 3 and, preferably, illuminates one or both sides of the sheet 3 in the region 15 detected by the camera 13. For instance, the source of electromagnetic radiation may illuminate the side of the sheet 3 on the reverse of the region 15 detected by the camera 13.

In some embodiments, the illuminator 14 is located at most 3 meters, at most 2 meters, at most 1 meter, at most 0.75 meters, at most 0.5 meters, at most 0.25 meters or at most 0.15 or 0.1 meters from the sheet 3.

The illuminator 14 is located on a side of the sheet 3 of aerosol-generating material that is opposite to the camera 13. It has been found that this arrangement is particularly effective at improving the ability of the camera 13 to detect defects. However, in some embodiments, there may be an illuminator 14 on both sides of the sheet 3 of aerosol-generating material, for example, above and below the sheet 3.

In the embodiment shown in FIG. 6, the camera 13 is located above the sheet 3 of aerosol-generating material and the illuminator 14 is located beneath the sheet 3 of aerosol-generating material opposite to the camera 13.

The illuminator 14 may comprise a filter (not shown). In some embodiments, the filter is configured to filter electromagnetic radiation of certain frequencies, for example, higher or lower than a predetermined value. The filter may be a high pass, low pass, or band pass filter. At least some of the electromagnetic radiation passed by the filter of the illuminator 14 is passed by the filter of the camera 13. Illuminating the sheet 3 with filtered electromagnetic radiation, for example, filtered light, allows the camera 13 to filter out background light, improving detection of the illuminating signal and the improving defect detection.

In some embodiments, the filter of the camera 13 and/or the filter of the illuminator 14 is a polarizing filter. Using a polarizing filter together with the camera 13 and illuminator 14 reduces the interference from environmental lighting and therefore improves the accuracy of the sheet analysis.

The camera 13 may be a color camera, grey scale, or black and white. In some embodiments, the camera 13 is an infrared camera.

In some embodiments, the controller 9 is configured to determine the size of a defect 6 in the sheet 3 of aerosol-generating material by performing a count of pixels that detect the presence of a defect 6. For example, a hole, or other defect, in the sheet 3 will be a different color and/or will be lighter or darker than the material of the sheet 3 itself. Additionally, an area of reduced density or thickness or increased porosity, for example, would result in a brighter region compared to the rest of the sheet 3 since the region would have a reduced propensity to block the light emitted from the illuminator 14.

Therefore, pixels imaged by the camera 13 in the region of a hole or other defect will have a non-standard property in comparison to pixels imaged in regions of the sheet 3 without such a hole. The non-standard property may include one or more of the lightness/darkness/color of the pixel.

It should be recognized that the camera 13 may also be used to determine the density, thickness and/or porosity of the sheet 3 without requiring an illuminator 14. For example, the camera 13 may be used to determine the density/thickness/porosity based on the color of the sheet 3 detected by the camera 13.

The controller 9 can determine the dimensions of the defect based on the number of pixels that have said non-standard property, for example, the number of pixels that are darker than usual and thus indicate the presence of a hole. In some embodiments, the controller 9 counts the number of adjacent pixels or pixels in a given area that have said non-standard property, for example, if the color is different to that expected by the presence of undamaged sheet material or if the lightness/darkness exceeds a threshold value.

The controller 9 may count the number of pixels having said non-standard property that fall adjacent, or proximate to each other, along the length of the sheet 3 (in the direction of the conveyance path 4) to determine the length of the defect 6. Additionally, or alternatively, the controller 9 may count the number of pixels having said non-standard property that fall adjacent, or proximate to each other, along the width W of the sheet 3 (perpendicular to the direction of the conveyance path 4) to determine the width of the defect 6.

In some embodiments, the controller 9 is configured to measure the surface area of the defect 6 by measuring both the length and width of the defect 6, or by counting the total number of pixels that fall adjacent that have said non-standard property.

The controller 9 is configured to relate images of the defect 6 in the sheet 3 of aerosol-generating material to one or more of: a specific region of the rod 8; a specific discrete rod 23; a batch of rods 23; and/or, a particular source of sheet material 3. The region of rod 8 with the defect 6, the particular discrete rod 23 comprising the defect 6, or the batch of discrete rods 23 that includes a rod 23 with a defect 6 can be removed if the defect 6 meets certain pre-set removal criteria and is thus classified as a defect 6 by the controller 9. For example, if the defect 6 has sufficient length, width and/or surface area, or if there is sufficient total number of defects 6.

In addition, a lighter/darker color then usual detected by the camera 13 indicates an area of non-uniformity of the thickness of the sheet 3. For example, a lighter color indicates that the sheet 3 is thinner than normal and a darker color indicates that the sheet is thicker than normal. The controller 9 may be configured to determine that there is a defect 6 if any of the pixels imaged by the camera 13 are above or below a threshold lightness/darkness, or if more than a certain number of pixels exceed a threshold lightness/darkness. Alternatively, all regions or substantially all regions of the sheet 3 are lighter/darker than usual, this indicates that the entire or substantially the entire sheet 3 has a sub-optimal thickness, density and/or porosity.

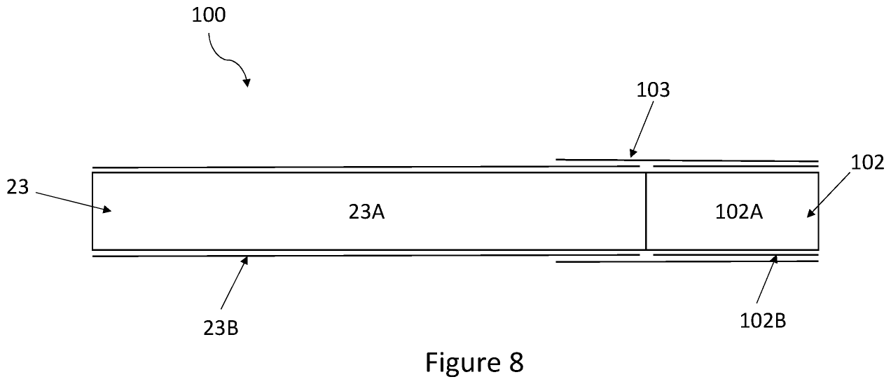

Referring now to FIG. 8, an embodiment of an aerosol provision system 100 is shown. In the present example, the aerosol provision system 100 is a combustible aerosol provision system 100, such as a cigarette. However, it should be recognized that the aerosol provision system 100 may also be a non-combustible aerosol provision system 100.

The aerosol provision system 100 comprises a consumable 23 manufactured by the apparatus 1 of any of FIGS. 1 to 7. In the present example, the consumable 23 is a rod.

The consumable 23 comprises an aerosol-generating material 23A, for example, tobacco, that has been manufactured by forming the sheet 3 of aerosol-generating material into a rod shape. The consumable 23 further comprises a wrapper 23B that circumscribes the aerosol-generating material 23A.

The aerosol provision system 100 further comprises a component 102 that is attached to the consumable 23 by a tipping paper 103 that overlies the component 102 and a portion of the consumable 23. In the present example, the component 102 is a filter and comprises a body of filter material 102A that is circumscribed by a plug wrap 102B.

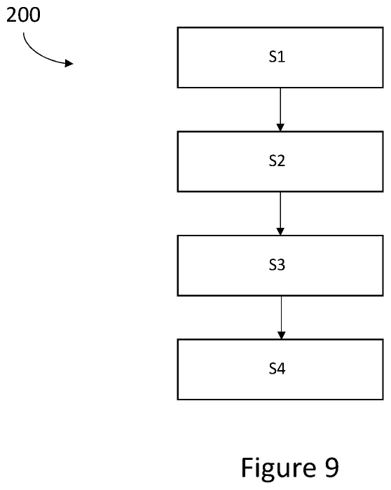

Referring now to FIG. 9, an embodiment of a method 200 of manufacturing a component for an aerosol-provision system is illustrated. The method 200 comprises feeding a sheet of aerosol-generating material along a conveyance path (step S1); detecting information indicative of defects in the sheet of aerosol-generating material as the sheet of aerosol-generating material passes along the conveyance path (step S2); forming the sheet of aerosol-generating material into a consumable (step S3); and, determining the presence of a defect in the consumable based on the detected information (step S4).

In other embodiments, the step (S2) of detecting information indicative of defects is performed prior to the sheet material 3 being passed along the conveyance path (for example, prior to the sheet material 3 being loaded into a feeding apparatus 2).

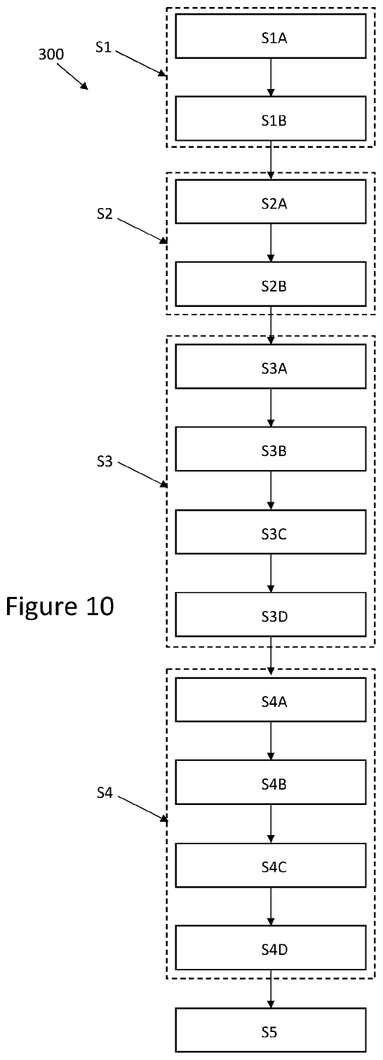

Referring now to FIG. 10, another embodiment of a method 300 of manufacturing a component for an aerosol-provision system is illustrated. The method 300 comprises feeding a sheet of aerosol-generating material along a conveyance path (step S1); so detecting information indicative of defects in the sheet of aerosol-generating material as the sheet of aerosol-generating material passes along the conveyance path (step S2); forming the sheet of aerosol-generating material into a consumable (step S3); and, determining the presence of a defect in the consumable based on the detected information (step S4). In other embodiments, the step (S2) of detecting information indicative of defects is performed prior to the sheet material 3 being passed along the conveyance path (for example, prior to the sheet material 3 being loaded into a feeding apparatus 2).

The step (S1) of feeding the sheet of aerosol-generating material along a conveyance path may comprise providing a continuous sheet of aerosol-generating material (step S1A) and feeding the continuous sheet of aerosol-generating material along the conveyance path (S1B). The sheet may be supplied from a bobbin.

The step (S2) of detecting information indicative of defects in the sheet may comprise illuminating the sheet of aerosol-generating material (step S2A). In some embodiments, the sheet is illuminated using electromagnetic radiation that has been filtered to only pass a specific frequency or range(s) of frequencies.

The step (S2) of detecting information indicative of defects in the sheet may comprise using a sensor to detect the presence of defects (step S2B). In some embodiments, the sensor comprises a signal transmitter and receiver, for example, a laser transmitter and receiver, and/or comprises a camera. In some embodiments, the sensor is filtered to only pass a specific frequency or range(s) of frequencies, which may be the same as or overlap with those passed in the filtering described above in relation to step S2A.

In some embodiments, detecting information indicative of defects in the sheet (step S2) may comprise using a plurality of sensors. The sensors may be arranged sequentially in a direction of the conveyance path. Alternatively, or additionally, the sensors may be offset along the width of the sheet.

The step (S3) of forming the sheet of aerosol-generating material into a consumable comprises forming the sheet of aerosol-generating material into strips (step S3A). This may include cutting at least a portion of the sheet of aerosol-generating material into strips. In other embodiments (not shown), the sheet may be folded into a consumable so rather than, or in addition to, being cut into strips.

The step (S3) of forming the sheet of aerosol-generating material into a consumable further comprises gathering the strips of aerosol-generating material (step S3B).

The step (S3) of forming the sheet of aerosol-generating material into a consumable further comprises wrapping the aerosol-generating material in a wrapper (step S3C).

The step (S3) of forming the sheet of aerosol-generating material into a consumable further comprises cutting the consumable into discrete consumables (step S3D). In some embodiments, the discrete consumables are single-length or double-length consumables.

The step (S4) of determining the presence of a defect in the consumable comprises determining one or more parameters of the defect (step S4A). The parameters of the defect may include one or more of the: length, width, depth, area of the defect or the density of the sheet. Alternatively, or additionally, the parameter may include one or more of the thickness or porosity of the sheet.

The step (S4) of determining the presence of a defect in the consumable further comprises comparing the parameter of the defect to one or more pre-set values (step S4B) and classifying the defect based on the comparison between parameters of the defect and the one or more pre-set values (step S4C).

The step (S4) of determining the presence of a defect in the consumable further comprises associating a defect with a discrete consumable (step S4D). Alternatively, or additionally, step S4A may comprise associating a defect with a batch of discrete consumables.

The method 300 further comprises sorting discrete consumables determined by the controller to comprise one or more defects from discrete consumables that are not determined by the controller to comprise one or more defects (step S5). Any discrete consumables which comprise a defect are removed from the apparatus and discarded or recycled.

It will be appreciated that one or more of the method steps described above may be omitted. Furthermore, steps of the method may be performed simultaneously or in a different order.

According to the present disclosure, an “aerosol provision system” refers to both a combustible aerosol provision system and a non-combustible aerosol provision system.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine.

In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint.

In some embodiments, the flavor comprises flavor components of cucumber, blueberry, citrus fruits and/or redberry. In some embodiments, the flavor comprises eugenol. In some embodiments, the flavor comprises flavor components extracted from tobacco.

In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An apparatus for manufacturing a consumable for an aerosol provision system, the apparatus comprising:
a feeding apparatus for receiving a sheet of aerosol-generating material and configured to supply the sheet of aerosol-generating material along a conveyance path;
a sensor configured to detect information indicative of defects in the sheet of aerosol-generating material as the sheet of aerosol-generating material passes along the conveyance path;
a consumable forming apparatus configured to receive the sheet of aerosol-generating material and form the sheet of aerosol-generating material into a consumable; and
a controller configured to determine the presence of a defect in the sheet of aerosol-generating material based on the information detected by the sensor.

2. The apparatus of claim 1, wherein the controller is configured to determine the location of the defect in the consumable formed by the consumable forming apparatus based on the information detected by the sensor.

3. The apparatus of claim 2, wherein the location of the defect includes the axial location of the defect along the consumable.

4. The apparatus of claim 1, wherein the controller is configured to determine one or more parameters of the defect and, preferably, the parameters of the defect includes one or more of the: length, width, depth, the angle of the extent of the defect with respect to the direction of the conveyance path, the area of the defect, the density of the sheet, the thickness of the sheet or the porosity of the sheet.

5. The apparatus of claim 4, wherein the controller is configured to compare the parameter of the defect to pre-set values.

6. The apparatus of claim 5, wherein the controller is configured to classify a defect based on the comparison between parameters of the defect and the pre-set values and, preferably, wherein the classification relates to the severity of the defect.

7. The apparatus of claim 1, wherein the controller is configured to determine the presence of a defect in at least one discrete region of the sheet of aerosol-generating material based on the information detected by the sensor.

8. The apparatus of claim 1, wherein the controller is configured to determine the presence of a defect present along substantially the entire length of the sheet of aerosol-generating material based on the information detected by the sensor.

9. The apparatus according to claim 8, wherein the defect is deviation of at least one parameter of the sheet present along substantially the entire length of the sheet from a target range or value and, preferably, wherein said parameter is one or more of the: thickness, density or porosity of the sheet.

10. The apparatus of claim 6, wherein the controller is configured to evaluate the quality of a region of the sheet of aerosol-generating material based on the quantity or surface density of the one or more defects within said region and/or the classifications of one or more of the defects within said region.

11. The apparatus of claim 10, wherein the evaluation of quality produces a quality metric, and preferably, wherein the controller is configured to store the metric in memory, and preferably wherein the metric is associated with said region.

12. The apparatus of claim 11, wherein the region of the sheet corresponds to aerosol-generating material of a discrete consumable or a batch of discrete consumables formed by the apparatus.

13. The apparatus of claim 10, wherein the controller is configured to perform a particular action dependent on the evaluation of the quality of the region.

14. The apparatus of claim 13, wherein the action comprises sending a signal indicating that the quality of the region is below a predefined value and, preferably, that the region and/or entire sheet material is to be discarded and/or recycled.

15. The apparatus of claim 13, wherein the action comprises sending a signal indicating that the consumable or batch of consumables comprising the region is to be sorted from other consumables or batches of consumables formed by the consumable forming apparatus if the evaluation of the quality of the region determines that the quality is below a predefined value and, preferably, that the consumable or batch of consumables comprising the region is to be discarded and/or recycled.

16. The apparatus of claim 1, wherein the sensor comprises a signal transmitter and signal receiver for defect detection and, preferably, the signal is a laser signal.

17. The apparatus of claim 1, comprising a plurality of sensors.

18. The apparatus of claim 17, wherein the sensors are configured to detect regions of the sheet that are offset in a direction perpendicular to the direction of the conveyance path and/or are configured to detect regions of the sheet that are offset in a direction along the conveyance path.

19. The apparatus of claim 1, wherein the sensor is configured to determine the topology of at least a portion of the sheet of aerosol-generating material.

20. The apparatus of claim 1, wherein the sensor is located above or below the sheet of aerosol-generating material.

21. The apparatus of claim 1 wherein the sensor comprises a camera.

22. The apparatus of claim 21, wherein the apparatus further comprises an illuminator configured to illuminate the sheet of aerosol-generating material.

23. The apparatus of claim 22, wherein the illuminator is located on a side of the sheet of aerosol-generating material that is distal to the camera.

24. The apparatus of claim 22, wherein the illuminator is located on both sides of the sheet of aerosol-generating material.

25. The apparatus of claim 22, wherein the illuminator comprises a filter.

26. The apparatus of claim 21, wherein the camera comprises a filter and, preferably, the filter is a polarizing filter.

27. The apparatus of claim 26, wherein the apparatus further comprises an illuminator configured to illuminate the sheet of aerosol-generating material and wherein the illuminator comprises a filter, wherein the filter of the illuminator is configured to pass electromagnetic radiation at least some of which has the same frequency as electromagnetic radiation passed by the filter of the camera.

28. The apparatus of claim 21, wherein the camera is a three-dimensional camera that is configured to detect three-dimensional images of the sheet.

29. The apparatus of claim 1, wherein the defect detected by the sensor include one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

30. The apparatus of claim 1, wherein the feeding apparatus supplies a continuous sheet of aerosol-generating material and, preferably the feeding apparatus comprises a bobbin receiving mechanism for receiving a bobbin of a sheet of aerosol-generating material and, preferably, the feeding apparatus comprises a bobbin of a sheet of aerosol-generating material.

31. The apparatus of claim 1, wherein the sheet of aerosol-generating material comprises tobacco.

32. The apparatus of claim 1, wherein the consumable forming apparatus comprises a strip forming apparatus that is configured to form the sheet of aerosol-generating material into strips.

33. The apparatus of claim 32, wherein the strip forming apparatus comprises a cutting apparatus configured to cut at least a portion of the sheet of aerosol-generating material into strips of aerosol-generating material.

34. The apparatus of claim 32, wherein the consumable forming apparatus comprises a gathering apparatus configured to gather the strips of aerosol-generating material.

35. The apparatus of claim 1, wherein the consumable forming apparatus comprises a wrapping apparatus configured to wrap the aerosol-generating material in a wrapper.

36. The apparatus of claim 1, wherein the consumable forming apparatus comprises a cutting apparatus for cutting the consumable into discrete consumables.

37. The apparatus of claim 36, wherein the discrete consumables are single-length or double-length consumables.

38. The apparatus of claim 36, wherein the controller is configured to associate a defect with a discrete consumable.

39. The apparatus of claim 36, wherein the controller is configured to associate a defect with a batch of discrete consumables formed by the consumable forming apparatus.

40. The apparatus of claim 39, wherein the apparatus comprises a sorting apparatus configured to remove discrete consumables determined by the controller to comprise one or more defects.

41. The apparatus of claim 1, wherein the consumable is a rod.

42. An apparatus for analyzing a sheet of aerosol-generating material to be formed into a consumable for an aerosol provision system, the apparatus comprising:
a sensor configured to detect information indicative of defects in a sheet of aerosol-generating material as the sheet of aerosol-generating material passes along a conveyance path; and,
a controller configured to determine the presence of a defect in the sheet of aerosol-generating material based on the information detected by the sensor.

43. (canceled)

44. A controller for an apparatus for analyzing a sheet of aerosol-generating material to be formed into a consumable for an aerosol provision system, the controller configured to connect to a sensor, wherein the sensor is configured to detect information indicative of defects in a sheet of aerosol-generating material, the controller configured to determine the presence of a defect in the sheet of aerosol-generating material based on the information detected by the sensor.

45. A controller according to claim 44, wherein the sensor is configured to detect information indicative of defects in the sheet of aerosol-generating material as the sheet of aerosol-generating material passes along a conveyance path or wherein the sensor is configured to detect information indicative of defects in a sheet of aerosol-generating material prior to the sheet of aerosol-generating material being fed along a conveyance path.

46. (canceled)

47. A method of manufacturing a consumable for an aerosol provision system, the method comprising:
feeding a sheet of aerosol-generating material along a conveyance path;
detecting information indicative of defects in the sheet of aerosol-generating material as the sheet of aerosol-generating material passes along the conveyance path;
forming the sheet of aerosol-generating material into a consumable; and
determining the presence of a defect in the consumable based on the detected information.

48. The method of claim 47, comprising determining the location of the defect in the formed consumable based on the detected information and, preferably, determining the axial location of the defect.

49. The method of claim 47, wherein the method comprises determining one or more parameters of the defect and, preferably, the parameters of the defect includes one or more of the: length, width, depth, the angle of the extent of the defect with respect to the direction of the conveyance path, the area of the defect, the density of the sheet, the thickness of the sheet or the porosity of the sheet.

50. The method of claim 49, comprising comparing the parameter of the defect to one or more pre-set values and, preferably, classifying the defect based on the comparison between parameters of the defect and the one or more pre-set values.

51. The method of claim 47, wherein determining the presence of a defect in the consumable based on the detected information comprises determining the presence of a defect in at least one discrete region of the sheet based on the information detected by the sensor.

52. The method of claim 47, wherein determining the presence of a defect in the consumable based on the detected information comprises determining the presence of a defect present along substantially the entire length of the sheet based on the information detected by the sensor.

53. The method of claim 52, wherein the defect is deviation of at least one parameter of the sheet present along substantially the entire length of the sheet from a target range or value and, preferably, wherein said parameter is one or more of the thickness, density or porosity of the sheet.

54. The method of claim 47, comprising using a sensor to detect the information indicative of defects and, preferably, and the sensor comprises a signal transmitter and signal receiver for defect detection.

55. The method of claim 54, wherein the sensor comprises multiple signal transmitters and signal receivers.

56. The method of claim 55, wherein the sensors are configured to detect regions of the sheet that are offset in a direction perpendicular to the direction of the conveyance path and/or are configured to detect regions of the sheet that are offset in a direction along the conveyance path.

57. The method of claim 54, wherein the sensor is located above or below the sheet of aerosol-generating material.

58. The method of claim 54, wherein the sensor comprises a camera and, preferably wherein the camera is a three-dimensional camera that is configured to detect three-dimensional images of the sheet.

59. The method of claim 58, wherein the camera comprises a filter and, preferably, the filter is a polarizing filter.

60. The method of claim 58, comprising illuminating the sheet of aerosol-generating material in a region of the sheet detected by the camera.

61. The method of claim 60, comprising illuminating the sheet form a side of the sheet that is distal from the camera.

62. The method of claim 60, comprising illuminating both sides of the sheet of aerosol-generating material.

63. The method of claim 60, wherein the sensor comprises a camera and, preferably wherein the camera is a three-dimensional camera that is configured to detect three-dimensional images of the sheet and wherein the camera comprises a filter and, preferably, the filter is a polarizing filter, the method further comprising illuminating the sheet of aerosol-generating material via a filter configured to filter electromagnetic radiation of the same frequency as the filter of the camera.

64. The method of claim 47, comprising determining the topology of at least a portion of the sheet of aerosol-generating material.

65. The method of claim 47, wherein the defect detected includes one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

66. The method of claim 47, wherein feeding a sheet of aerosol-generating material along a conveyance path comprises feeding a continuous sheet of aerosol-generating material and, preferably, the sheet is supplied from a bobbin.

67. The method of claim 47, wherein the sheet of aerosol-generating material comprises tobacco.

68. The method of claim 47, wherein forming the sheet of aerosol-generating material into a consumable comprises forming the sheet of aerosol-generating material into strips and, preferably, comprises cutting at least a portion of the sheet of aerosol-generating material into strips.

69. The method of claim 68, wherein forming the sheet of aerosol-generating material into a consumable comprises gathering the strips of aerosol-generating material.

70. The method of claim 47, wherein forming the sheet of aerosol-generating material into a consumable comprises wrapping the aerosol-generating material in a wrapper.

71. The method of claim 47, wherein forming the sheet of aerosol-generating material into a consumable comprises cutting the consumable into discrete consumables and, preferably, the discrete consumables are single-length or double-length consumables.

72. The method of claim 71, comprising associating a defect with a discrete consumable.

73. The method of claim 72, comprising sorting discrete consumables determined by the controller to comprise one or more defects from discrete consumables that are not determined by the controller to comprise one or more defects.

74. The method of claim 71, comprising associating a defect with a batch of discrete consumables.

75. The method of claim 47, wherein the consumable is a rod.

76. An apparatus for analyzing a sheet of aerosol-generating material for an aerosol provision system consumable, the apparatus comprising:
a sensor configured to detect information indicative of defects in a sheet of aerosol-generating material; and,
a controller configured to determine the presence of a defect in the sheet of aerosol-generating material based on the information detected by the sensor.

77. The apparatus of claim 76, wherein the controller is configured to determine one or more parameters of the defect and, preferably, the parameters of the defect includes one or more of the: length, width, depth, the angle of the extent of the defect, the area of the defect, the density of the sheet, the thickness of the sheet or the porosity of the sheet.

78. The apparatus of claim 77, wherein the controller is configured to compare the parameter of the defect to pre-set values.

79. The apparatus of claim 78, wherein the controller is configured to classify a defect based on the comparison between parameters of the defect and the pre-set values and, preferably, wherein the classification relates to the severity of the defect.

80. The apparatus of claim 76, wherein the controller is configured to determine the presence of a defect in at least one discrete region of the sheet of aerosol-generating material based on the information detected by the sensor.

81. The apparatus of claim 76, wherein the controller is configured to determine the presence of a defect present along substantially the entire length of the sheet of aerosol-generating material based on the information detected by the sensor.

82. The apparatus according to claim 76, wherein the defect is deviation of at least one parameter of the sheet present along substantially the entire length of the sheet from a target range or value and, preferably, wherein said parameter is one or more of the: thickness, density or porosity of the sheet.

83. The apparatus of claim 76, wherein the controller is configured to evaluate the quality of a region of the sheet of aerosol-generating material based on the quantity or surface density of the one or more defects within said region and/or the classifications of one or more of the defects within said region.

84. The apparatus of claim 83, wherein the evaluation of quality produces a quality metric, and preferably, wherein the controller is configured to store the metric in memory, and preferably wherein the metric is associated with said region.

85. The apparatus of claim 84, wherein the region of the sheet corresponds to aerosol-generating material of a discrete consumable or a batch of discrete consumables formed by the apparatus.

86. The apparatus of claim 83, wherein the controller is configured to perform a particular action dependent on the evaluation of the quality of the region.

87. The apparatus of claim 86, wherein the action comprises sending a signal indicating that the quality of the region is below a predefined value and, preferably, that the region and/or entire sheet material is to be discarded and/or recycled.

88. The apparatus of claim 76, wherein the sensor comprises a signal transmitter and signal receiver for defect detection and, preferably, the signal is a laser signal.

89. The apparatus of claim 76, comprising a plurality of sensors.

90. The apparatus of claim 76, wherein the sensor is configured to determine the topology of at least a portion of the sheet of aerosol-generating material.

91. The apparatus of claim 76 wherein the sensor comprises a camera.

92. The apparatus of claim 91, wherein the apparatus further comprises an illuminator configured to illuminate the sheet of aerosol-generating material.

93. The apparatus of claim 92, wherein the illuminator is configured to be located on a side of the sheet of aerosol-generating material that is distal to the camera.

94. The apparatus of claim 92, wherein the illuminator is configured to be located on both sides of the sheet of aerosol-generating material.

95. The apparatus of claim 92, wherein the illuminator comprises a filter.

96. The apparatus of claim 92, wherein the camera comprises a filter and, preferably, the filter is a polarizing filter.

97. The apparatus of claim 96, wherein the illuminator comprises a filter, wherein the filter of the illuminator is configured to pass electromagnetic radiation at least some of which has the same frequency as electromagnetic radiation passed by the filter of the camera.

98. The apparatus of claim 92, wherein the camera is a three-dimensional camera that is configured to detect three-dimensional images of the sheet.

99. The apparatus of claim 76, wherein the defect detected by the sensor include one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

100. The apparatus of claim 76, wherein the sheet of aerosol-generating material comprises tobacco.

101. An apparatus for manufacturing a consumable for an aerosol provision system, the apparatus comprising:
the apparatus for analyzing a sheet of aerosol-generating material according to claim 76;
a feeding apparatus for receiving a sheet of aerosol-generating material and configured to supply the sheet of aerosol-generating material along a conveyance path; and,
a consumable forming apparatus configured to receive the sheet of aerosol-generating material and form the sheet of aerosol-generating material into a consumable.

102. A method of analyzing a sheet of aerosol-generating material for an aerosol provision system consumable, the method comprising:
detecting information indicative of defects in the sheet of aerosol-generating material; and
determining the presence of a defect in the consumable based on the detected information.

103. The method of claim 102, wherein the method comprises determining one or more parameters of the defect and, preferably, the parameters of the defect includes one or more of the: length, width, depth, the angle of the extent of the defect, the area of the defect, the density of the sheet, the thickness of the sheet or the porosity of the sheet.

104. The method of claim 103, comprising comparing the parameter of the defect to one or more pre-set values and, preferably, classifying the defect based on the comparison between parameters of the defect and the one or more pre-set values.

105. The method of claim 102, wherein determining the presence of a defect in the consumable based on the detected information comprises determining the presence of a defect in at least one discrete region of the sheet based on the information detected by the sensor.

106. The method of claim 102, wherein determining the presence of a defect in the consumable based on the detected information comprises determining the presence of a defect present along substantially the entire length of the sheet based on the information detected by the sensor.

107. The method of claim 106, wherein the defect is deviation of at least one parameter of the sheet present along substantially the entire length of the sheet from a target range or value and, preferably, wherein said parameter is one or more of the thickness, density or porosity of the sheet.

108. The method of claim 102, comprising using a sensor to detect the information indicative of defects and, preferably, and the sensor comprises a signal transmitter and signal receiver for defect detection.

109. The method of claim 108, wherein the sensor comprises multiple signal transmitters and signal receivers.

110. The method of claim 108, wherein the sensor comprises a camera and, preferably wherein the camera is a three-dimensional camera that is configured to detect three-dimensional images of the sheet.

111. The method of claim 110, wherein the camera comprises a filter and, preferably, the filter is a polarizing filter.

112. The method of claim 110, comprising illuminating the sheet of aerosol-generating material in a region of the sheet detected by the camera.

113. The method of claim 112, comprising illuminating the sheet from a side of the sheet that is distal from the camera.

114. The method of claim 112, comprising illuminating both sides of the sheet of aerosol-generating material.

115. The method of claim 112, wherein the camera comprises a filter and, preferably, the filter is a polarizing filter, the method further comprising illuminating the sheet of aerosol-generating material via a filter configured to filter electromagnetic radiation of the same frequency as the filter of the camera.

116. The method of claim 102, comprising determining the topology of at least a portion of the sheet of aerosol-generating material.

117. The method of claim 102, wherein the defect detected includes one or more of holes, slits, non-uniformity in the thickness of the sheet, areas of reduced density, voids, tears, lumps, the thickness of the sheet deviating from a desired range or value, the density of the sheet deviating from a desired range or value, and/or the porosity of the sheet deviating from a desired range or value.

118. The method of claim 102, wherein the sheet of aerosol-generating material comprises tobacco.

119. A method of manufacturing a consumable for an aerosol provision system, the method comprising: analyzing a sheet of aerosol-generating material for an aerosol provision system consumable according to the method of claim 102, the method further comprising forming the sheet of aerosol-generating material into a consumable.

120. A consumable for an aerosol provision system manufactured by the apparatus of claim 1.

121. A system for manufacturing a consumable for an aerosol provision system, the system for manufacturing a consumable comprising:
an apparatus for analyzing a sheet of aerosol-generating material for an aerosol provision system consumable according to claim 76;
a feeding apparatus for receiving a sheet of aerosol-generating material and configured to supply the sheet of aerosol-generating material along a conveyance path; and,
a consumable forming apparatus configured to receive the sheet of aerosol-generating material and form the sheet of aerosol-generating material into a consumable.

122. (canceled)
